(19) United States
(12) Patent Application Publication
(10) Pub. No.: US 2012/0147749 A1
(43) Pub. Date: Jun. 14, 2012

(54) ROUTING APPARATUS AND METHOD FOR MOBILE AD-HOC NETWORK

(75) Inventors: Sung-Jin MOON, Daejeon-si (KR); Hwan-Jo HEO, Daejeon-si (KR); Nam-Seok KO, Daejeon-si (KR); Woo-Sug JUNG, Daejeon-si (KR); Sung-Kee NOH, Daejeon-si (KR); Byung-Ho YAE, Daejeon-si (KR); Jong-Dae PARK, Daejeon-si (KR)

(73) Assignee: Electronics and Telecommunications Research Institute, Daejeon-si (KR)

(21) Appl. No.: 13/307,628

(22) Filed: Nov. 30, 2011

(30) Foreign Application Priority Data
Dec. 9, 2010 (KR) 10-2010-0125442

(51) Int. Cl. H04W 72/10; H04L 12/26; H04W 40/00

(52) U.S. Cl. 370/235; 370/338

(57) ABSTRACT

A routing apparatus and method for a mobile ad-hoc network are provided. The routing apparatus selects a transmission path differently based on the priority of a message, thereby distributing paths such that the overall energy balance between mobile nodes can be maintained. Accordingly, congestion of traffic on a particular path can be prevented, and the overall performance and the lifetime of the network can be enhanced.

### CROSS-REFERENCE TO RELATED APPLICATION(S)

This application claims the benefit under 35 U.S.C. §119(a) of Korean Patent Application No. 10-2010-0125442, filed on Dec. 9, 2010, in the Korean Intellectual Property Office, the entire disclosure of which is incorporated herein by reference for all purposes.

### BACKGROUND

1. Field

The following description relates to a routing technique, and more particularly, to a routing apparatus and method for a mobile ad-hoc network.

2. Description of the Related Art

In a mobile ad-hoc network (MANET), efficient path building for routing is required due to frequent changes in phase caused by the moving of nodes and inability to process information of the whole networks in a centralized manner.

However, even if the efficient path building is successful, congestion of traffic on an optimal path needs to be solved for practical application of the efficient path building. Since mobile nodes share a limited amount of energy in a network, the congestion exhausts the energy of each mobile node on the optimal path.

As a result, uneven consumption of energy among the mobile nodes occurs, and thereby the overall network performance is deteriorated. In poor conditions (for example, on a mountain, the sea, or the like) for power supply, inefficient energy consumption makes it impossible to constantly use the mobile node, and especially in a battlefield, such difficulty in continuously using the mobile node may cause urgent circumstances.

Hence, a technology is suggested for distributing paths such that the overall energy balance among mobile nodes can be maintained and congestion of traffic on an optimal path can s be prevented, thereby efficiently increasing the overall performance and lifetime of the network.

### SUMMARY

The following description relates to a routing apparatus and method for a mobile ad-hoc network, which selects a transmission path differently based on the priority of a message, thereby distributing paths such that the overall energy balance between mobile nodes can be maintained.

In one general aspect, there is provided a routing apparatus for a mobile ad-hoc network, including: a priority determination unit configured to determine a priority of a message to be transmitted from a start node to a destination node; a transmission path selection unit configured to select one path, which corresponds to the determined priority of the message, as a transmission path among a plurality of paths from the start node to the destination node; and a message transmission unit configured to transmit the message through the transmission path selected by the transmission path selection unit.

Other features and aspects may be apparent from the following detailed description, the drawings, and the claims.

### BRIEF DESCRIPTION OF THE DRAWINGS

FIG. 1 is a diagram illustrating an example of a routing apparatus for a mobile ad-hoc network according to an exemplary embodiment of the present invention.

FIG. 2 is a diagram illustrating an example of paths of a mobile ad-hoc network.

FIG. 3 is a diagram illustrating an example of a table showing information about the paths shown in FIG. 2.

FIG. 4 is a diagram illustrating an example of a path selection table showing paths selected based on priority of messages.

FIG. 5 is a flowchart depicting an example of a routing method for a mobile ad-hoc network according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein may suggest themselves to those of ordinary skill in the art. Descriptions of well-known functions and structures are omitted to enhance clarity and conciseness.

In the following description, a detailed description of known functions and configurations incorporated herein will be omitted when it may obscure the subject matter with unnecessary detail.

Before describing the exemplary embodiments, terms used throughout this specification are defined. These terms are defined in consideration of functions according to exemplary embodiments, and can be varied according to a purpose of a user or manager, or precedent and so on. Therefore, definitions of the terms should be made on the basis of the overall context.

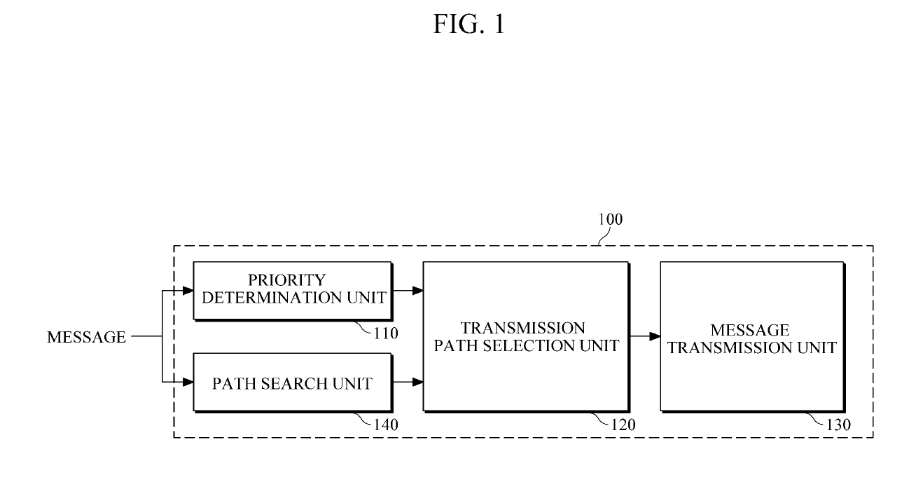

FIG. 1 illustrates an example of a routing apparatus for a mobile ad-hoc network according to an exemplary embodiment of the present invention. Referring to FIG. 1, the routing apparatus 100 may include a priority determination unit 110, a transmission path selection unit 120, and a message transmission unit 130.

The priority determination unit 110 may determine priority of messages to be transmitted from a start node to a destination node. In this case, the priority determination unit 110 may take the importance of messages into consideration in determining the priority.

For example, the priority determination unit 110 may assign a higher priority to a more important message. In this case, a message that is more sensitive to a delay time may have higher importance.

For example, the priority determination unit 110 may assign the highest priority to an urgent message that is sensitive to a delay time or to a message to be broadcasted over a network, and may assign the lowest priority to a message that is the least sensitive to a delay time.

The transmission path selection unit 120 may select one path among a plurality of paths from the start node to the destination node based on the priority of a message that is determined by the priority determination unit 110.

In this case, the transmission path selection unit 120 may select the shortest path for a message having the highest priority, and select a path that can maintain the overall energy balance of the network for a message having the lowest priority.

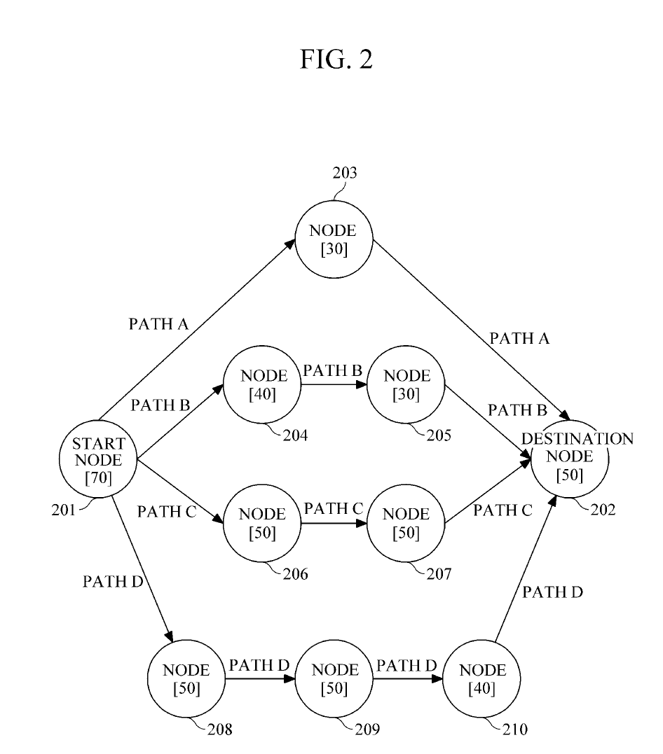

FIG. 2 illustrates an example of paths of a mobile ad-hoc network. In the network shown in FIG. 2, there are four paths from a start node 201 to a destination node 202. The number of hops included in each path is the number of nodes included in the path excluding the start node, and energy retained by each node is represented as a number in parentheses. For example, the retained energy may be available resource.

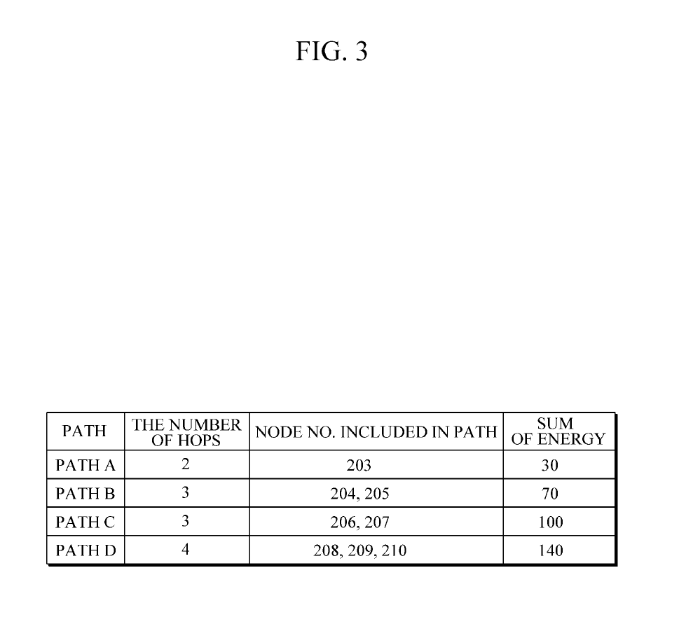

Referring to FIG. 2, path A has two hops, and the sum of energy of nodes on the path is 30. Path B has three hops, and the sum of energy of nodes is 70. Path C has three hops, and the sum of energy of nodes is 100. Path D has four hops, and the sum of energy of nodes is 140. Information about each path is shown in a table illustrated in FIG. 3. FIG. 3 illustrates an example of a table showing information about the paths shown in FIG. 2.

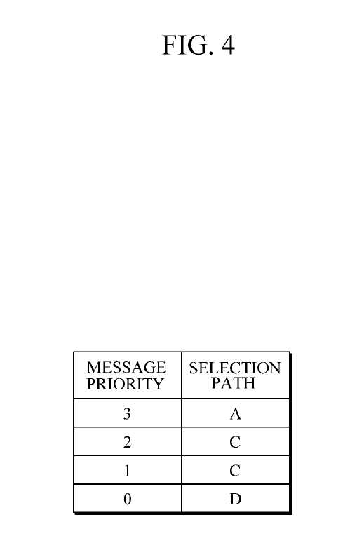

FIG. 4 illustrates an example of a path selection table showing paths selected based on priority of messages. In the table shown in FIG. 4, a higher value indicates a higher priority of a message.

For example, since an urgent message that is sensitive to a delay time or a message to be broadcasted over the whole network has a priority of ‘3,’ the message may be assigned the shortest path A with one hop so as to reduce a delay time, despite of a relatively low sum of energy ‘30’.

For a message that is the least sensitive to a delay time and has a priority of ‘0,’ the path D which is the longest with four hops, but has the largest sum of energy, ‘140,’ is selected in order not to disturb the overall energy balance of the network.

The paths B and C have the same number of hops and different energy sum. To maintain the overall energy balance of the network, it is more advantageous to select the path C prior to the path B since the path C has a greater energy sum than the path D, and thus a message having a priority of ‘1’ or ‘2’ is assigned the path C as a transmission path.

By doing so, the transmission path selection unit 120 selects different transmission paths according to the priority of messages, and hence the paths are allowed to be distributed so that the overall energy balance between the mobile nodes can be maintained.

The message transmission unit 130 may transmit the message through the transmission path selected by the transmission path selection unit 120. In other words, a message is transmitted from the start node to the destination node through a transmission path that is selected differently based on the priority of the message, and thereby the paths are distributed to maintain the overall energy balance among mobile nodes.

Accordingly, the routing apparatus of the mobile ad-hoc network according to the exemplary embodiment may prevent congestion of traffic on a particular path, and the overall performance and lifetime of the network can be effectively enhanced.

In another example, the routing apparatus 100 of the mobile ad-hoc network may further include a path search unit 140. The path search unit 140 may search for a plurality of paths from the start node to the destination node.

For example, the path search unit 140 may utilize ant colony optimization (ACO) to search for paths having superior pheromone values among paths from the start node to the destination node based on the pheromone values managed by each node.

Recently bio-inspired algorithms have been proposed to a field of network routing, which take inspiration from physiological activities of animals or insects and simulate their behaviors to be partially or fully applied to routing schemes. As a typical type of the bio-inspired algorithms, the ant colony optimization (ACO) has been widely used in many applications of routing.

The ACO is an optimization algorithm that stimulates the foraging behavior of real ant colonies. The ACO enables to establish an optimized routing path using simple information, i.e., a pheromone value which is managed and controlled by each mobile node.

Similar to behavior of ant colonies, artificial ants deposit pheromone on each node that the ants have passed. As a result, an optimal routing path from the start node to the destination node is obtained which is composed of mobile nodes that have the largest pheromone values.

The paths found by the path search unit 140 may be taken as reference for selection of an optimal path that corresponds to a priority of a message that has been determined by the priority determination unit 110, and one of the found paths may be selected as a transmission path.

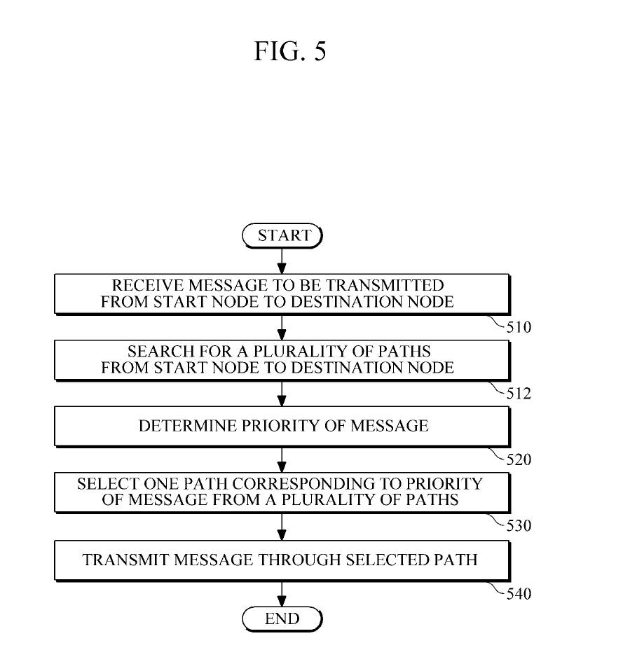

Routing operation of the aforementioned routing apparatus in the mobile ad-hoc network will be described with reference to FIG. 5. FIG. 5 illustrates a flowchart of an example of a routing method for a mobile ad-hoc network according to an exemplary embodiment of the present invention.

In operation 510, the routing apparatus receives a message to be transmitted from the start node to the destination node.

In operation 520, the routing apparatus determines a priority of the message. The routing apparatus may determine a priority of the message in consideration of the importance of the message.

For example, in operation 520, the routing apparatus may assign a higher priority to a message having a higher importance. In this case, a message that is more sensitive to a delay time may have a higher importance.

In operation 520, for example, the routing apparatus may assign the highest priority to an urgent message that is sensitive to a delay time or to a message to be broadcasted over the whole network, and may assign the lowest priority of a message that is least sensitive to a delay time.

In operation 530, the routing apparatus selects a path that corresponds to the priority of the message that is determined in operation 520 from among a plurality of paths from the start node to the destination node.

In operation 530, the routing apparatus may select the shortest path as a transmission path for the message having the highest priority, and select a path that can maintain overall energy balance of the network, as a transmission path, for a message having the lowest priority.

Accordingly, the routing apparatus selects a transmission path that is selected differently based on the priority of the message, and thereby the paths are distributed so that the overall energy balance between the mobile nodes can be maintained.

Then, in operation 540, the routing apparatus transmits the message through the transmission path selected in operation 530. The message is transmitted from the start node to the destination node through the transmission path that has been selected differently based on the priority of the message, and thus the paths are allowed to be distributed to maintain the overall energy balance between the mobile nodes. Consequently, congestion of traffic on a particular path can be prevented, and the overall performance and the lifetime of the network can be enhanced.

In another example, the routing method may further include path search operation. In operation 512, a plurality of paths from the start node to the destination node are searched for in response to receiving the message to be transmitted from the start node to the destination node in operation 510.

For example, in operation 512, the routing apparatus may use ACP algorithm to search for paths which have superior pheromone values managed by each node from among a plurality of paths from the start node and the destination node.

The paths found in operation 512 may be taken as reference to select one path that corresponds to the priority of the message in operation 530, and thus one of the paths found in operation 512 is selected as the transmission path.

As described above, a transmission path is selected differently based on the priority of a message, and hence paths are enabled to be distributed so that the overall energy balance between the mobile nodes can be maintained. Therefore, congestion of traffic on a particular path can be prevented, and the overall performance and the lifetime of the network can be enhanced.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A routing apparatus for a mobile ad-hoc network, comprising:
a priority determination unit configured to determine a priority of a message to be transmitted from a start node to a destination node;
a transmission path selection unit configured to select one path, which corresponds to the determined priority of the message, as a transmission path among a plurality of paths from the start node to the destination node; and
a message transmission unit configured to transmit the message through the transmission path selected by the transmission path selection unit.

2. The routing apparatus of claim 1, wherein the priority determination unit takes into consideration importance of a message when determining a priority of the message.

3. The routing apparatus of claim 2, wherein the priority determination unit assigns a higher priority to a message having a higher importance.

4. The routing apparatus of claim 3, the importance of the message is increased as the message is more sensitive to a delay time.

5. The routing apparatus of claim 2, wherein the priority determination unit assigns the highest priority to an urgent message or a message to be broadcasted over the whole network.

6. The routing apparatus of claim 1, wherein the transmission path selection unit selects the shortest path from among a plurality of the paths as the transmission path for a message having the highest priority.

7. The routing apparatus of claim 1, wherein the transmission path selection unit selects a path that can maintain the overall energy balance of the network as the transmission path for a message having the lowest priority.

8. The routing apparatus of claim 1, further comprising:
a path search unit configured to search for a plurality of the paths from the start node to the destination node.

9. The routing apparatus of claim 8, wherein the path search unit searches for paths from the start node to the destination node which have superior pheromone values using ant colony optimization (ACO) algorithm by which a path is established using pheromone values managed by each node.

10. A routing method for a mobile ad-hoc network, comprising:
receiving, at a routing apparatus, a message to be transmitted from a start node to a destination node;
determining, at the routing apparatus, a priority of the message to be transmitted from the start node to the destination node;
selecting, at the routing apparatus, one path that corresponds to the determined priority of the message from among a plurality of paths from the start node to the destination node as a transmission path; and
transmitting from the routing apparatus the message through the selected transmission path.

11. The method of claim 10, wherein the determining of the priority of the message takes into consideration the importance of the message.

12. The method of claim 11, wherein the determining of the priority of the message comprises assigning, at the routing apparatus, a higher priority to a message having a higher importance.

13. The method of claim 12, wherein the importance of the message is increased as the message is more sensitive to a delay time.

14. The method of claim 11, wherein the determining of the priority of the message comprises assigning, at the routing apparatus, the highest priority to an urgent message or a message to be broadcasted over the whole network.

15. The method of claim 10, wherein the selecting of the transmission path comprises selecting the shortest path as the transmission path for a message having the highest importance.

16. The method of claim 10, wherein the selecting of the transmission path comprises assigning, at the routing apparatus, a path that can maintain the overall energy balance of the network as a transmission path for a message having the lowest priority.

17. The method of claim 10, further comprising:
searching for, at the routing apparatus, a plurality of paths from the start node to the destination node.
